(19) United States
(12) Patent Application Publication
(10) Pub. No.: US 2008/0055904 A1
(43) Pub. Date: Mar. 6, 2008

(54) Patterned decorations with shining structures

(76) Inventor: Hung-Huei Chung, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/512,288

(22) Filed: Aug. 30, 2006

(51) Int. Cl. F21S 13/14

(52) U.S. Cl. 362/252

(57) ABSTRACT

The invention relates to an improved patterned decoration with shining structures, which includes a lot of bulbs on the decoration. A lot of shining sets including reflective pieces are also provided on the decoration. Hence, the bulbs and the swinging reflective pieces can emit rays outward at the same time that obtains a perfect decorative shining effect without increasing use of bulbs.

### BACKGROUND OF THE INVENTION

In order to provide a good decorative effect, some patterned decorations are provided, as shown in FIGS. 1 and 2, wherein bulbs are directly mounted thereon or a light string is winded. In use of bulbs (2) on the decoration (1), they emit rays outward to display the patterned outlook. It reaches the preset decorative purpose, especially at night. But in this conventional design, if the bulbs (2) are not enough, the lighting effect of the patterned decoration will be poor. If more bulbs (2) are provided, the cost will be high and it increases the total weight that is a burden to the patterned decoration. Further, power supplier will become another problem.

### SUMMARY OF THE INVENTION

It is an object of the present invention to provide an improved decorative design for patterned decorations to overcome the drawback of prior art, which includes a lot of shining sets for being mounted on the patterned decoration and obtains a perfect lighting effect. Now, accompanying with the following drawings, the character of the present invention will be described here and after.

### BRIEF DESCRIPTION OF THE DRAWINGS

FIG. 1 is a perspective view showing a conventional patterned decoration connecting with bulbs thereon.

FIG. 2 is a plan view of FIG. 1.

FIG. 3 is a perspective view showing a patterned decoration with shining structures according to the present invention.

FIG. 4 is a plan view of FIG. 3 showing cross-sectional views of shining sets.

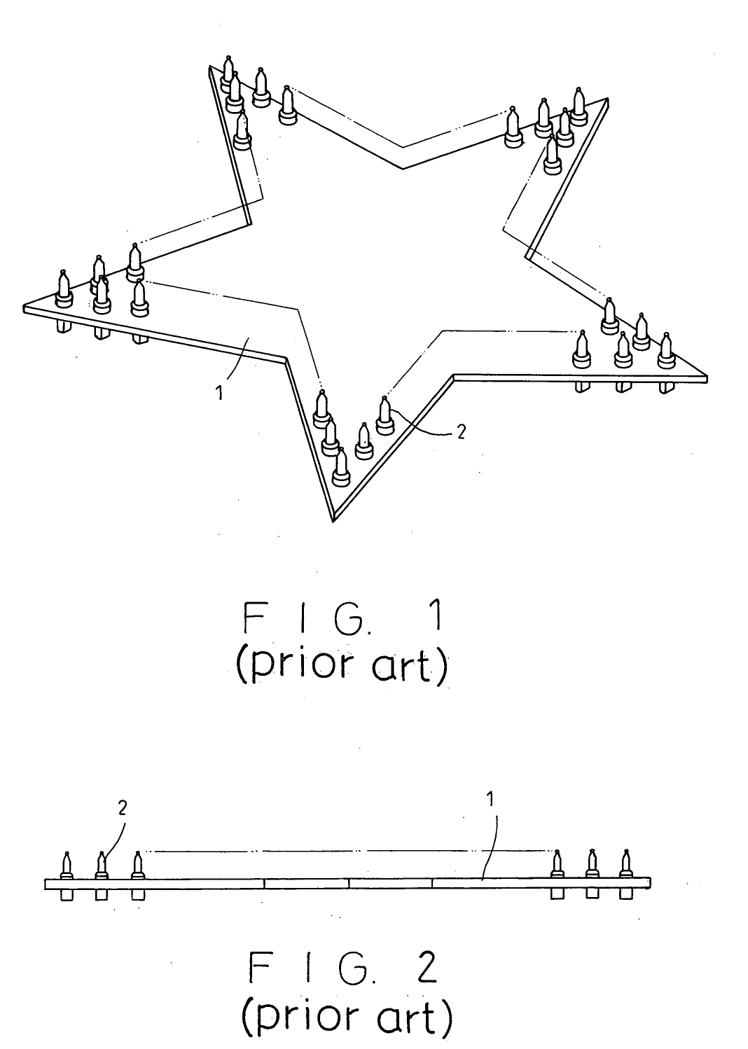

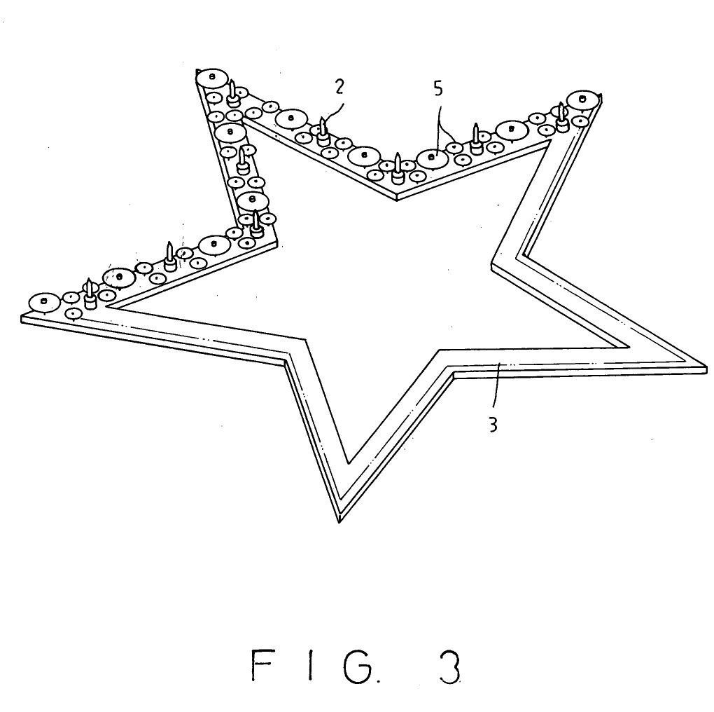

### DETAILED DESCRIPTION OF THE PREFERRED EMBODIMENT

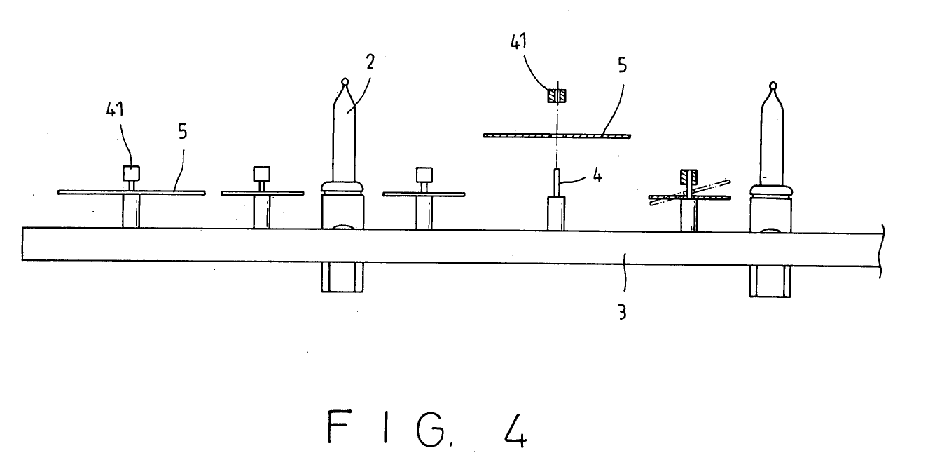

Referring to FIGS. 3 and 4, the present invention relates to a patterned decoration with shining structures, wherein the decoration can be changed to any suitable outlook and in this embodiment, a star ornament (3) for example. Bulbs (2) are mounted on the star ornament (3). The character of the present invention is in that a lot of shining sets are also provided on the ornament (3). The shining set includes a connecting rod (4) and a cap (41). A reflecting piece (5) is placed on the rod (4) and is capable of swinging. And the reflecting piece (5) may have various sizes and connects with the rod (4) at a non-central position.

Accordingly, the ornament (3) of the present invention has many bulbs (2), which emit rays outward directly and the reflective piece (5) can then reflect rays of the bulb (2) at the same time. Hence, the decoration connected the shining structure of the present invention displays a better lighting effect. Accompanying with the swinging pieces, the patterned decoration can obtain a best shining decorative effect without increasing use of bulbs.

Above all, it is the main object of the present invention to use shining sets provided on a patterned decoration, wherein the shining sets have reflective pieces for increasing the lighting effect under the same numbers of bulbs. Hence, the present invention obtains improved utilization and should be allowed for a patent.

1. A decorative structure with shining elements, comprising:
a patterned decoration: and
a plurality of bulbs mounted on the decoration in spaced relationship one from another: and
a plurality of shining sets respectively mounted on the decoration in spaced relationship with respect to the plurality of bulbs to reflect light therefrom, each shining set including a connecting rod extending from the patterned decoration, a reflective piece angularly and displaceably mounted on the connecting rod, and a cap disposed on a distal end of the connecting rod to retain the reflecting piece.

2. The decorative structure structures as claimed in claim 1, wherein the reflective piece is eccentrically mounted to the connecting rod.

3. (canceled)
